(19) United States
(12) Patent Application Publication
(10) Pub. No.: US 2004/0016391 A1
(43) Pub. Date: Jan. 29, 2004

(54) Tennis scoring apparatus

(76) Inventor: Avron L. Gordon, Plymouth, MN (US)

Correspondence Address: BRIGGS AND MORGAN, P.A., 2400 IDS CENTER, MINNEAPOLIS, MN, 55402, US

(21) Appl. No.: 10/202,930

(22) Filed: Jul. 25, 2002

(51) Int. Cl. A63F 11/00; G09F 11/04

(52) U.S. Cl. 116/223; 116/318

(57) ABSTRACT

The present invention provide a tennis scoring apparatus wherein a scoreboard will have a baseplate having at least a pair of windows extending therethrough and a pair of scoring wheels with numerals displayed thereon in numerical order from 1 to 8 rotatably attached to the baseplate such that as the scoring wheel is rotated about its attachment to the baseplate the numerals displayed on the scoring wheels will successively appear in the windows. Thus, as a point is scored by a player during the game, the appropriate player's scoring wheel can be rotated such that the correct number of points is showing through the window.

### FIELD OF THE INVENTION

The present invention relates generally to games in which scores are kept and particularly to an apparatus and method for scoring the game of tennis.

### BACKGROUND OF THE INVENTION

The scores in games of tennis are generally compiled, recorded or otherwise kept track of in the following ways: (1) the players call out the scores continuously after each point, game and set; (2) the score is called out and recorded by an umpire or similar person; (3) and the score is posted on a board. In addition, at courtside, the score may be recorded and displayed by the players themselves. The typical device used for courtside scoring in tennis matches is the “T-numerals.” This device consists of a pole or standard that is disposed in a substantially vertical position, with the standard often being affixed to one of two posts on each tennis court to which the tennis net is fastened. A cross-piece is attached substantially at the center thereof to the upper end of the standard to form the “T”. Two sets of rectangular panels displaying numerals are rotationally attached to cross-piece and hang suspended therefrom, with one set being disposed one each side of the standard. Rotating or flipping a rectangular panel results a new numeral being displayed. Usually the numerals are in different colors for each team or player.

The T-numeral arrangement has had little or no improvement over the years and has deficiencies including, without limitation, that:

(a) the numerals are subject to breakage;

(b) the numerals require frequent replacement or maintenance; and

(c) the numerals are subject to theft.

It would be desirable to have a scoring apparatus for use in sports including the game of tennis that was not subject to the foregoing deficiencies.

### SUMMARY OF THE PRESENT INVENTION

It is an object of the present invention to provide new and improved apparatus that is not subject to the deficiencies of the prior art.

It is a further object of the present invention to provide new and improved apparatus that can be easily used by tennis players to keep score during a game.

It is another object of the present invention to provide new and improved apparatus that is subject to little or no maintenance.

It is still a further object of the present invention to provide new and improved apparatus that is less subject to breakage than the prior art “T-numeral” device.

It is another further object of the present invention to provide new and improved apparatus that clearly displays the score of a tennis game.

The foregoing objects of the present invention are provided by a tennis scoring apparatus wherein a scoreboard is mounted to the upper end of an upright standard or pole. The scoreboard is preferably configured substantially as a disk and in a preferred embodiment substantially takes on the general design and color of a tennis ball. The scoreboard will include a baseplate having at least a pair of windows extending therethrough. A pair of scoring wheels with numerals displayed thereon in numerical order from 1 to 8 is rotatably attached to the baseplate such that as the scoring wheel is rotated about its attachment to the baseplate the numerals displayed on the scoring wheels will successively appear in the windows. Thus, as a point is scored by a player during the game, the appropriate player's scoring wheel can be rotated such that the correct number of points is showing through the window.

In another embodiment of the present invention, the novel scoreboard of the present invention may encompass a pair of spaced apart baseplates with the rotatable scoring wheels attached therebetween. Each of the scoring wheels will include numerals on both sides thereof and each of the baseplates will include at least a pair of windows, thus providing for a scoreboard clearly readable from both the front and rear sides.

As a further advantage of the present invention, the distinctive, circular shape is easily recognizable as that of a tennis-ball shape and is conducive to product advertising placements for a variety of products or services, including but not limited to the name or logo type of a tennis ball, tennis racket, or tennis clothing manufacturer.

The objects, features, and advantages of the present invention are evident for those skilled in the art from the following description of a preferred embodiment of the invention with reference to the accompanying drawings.

### BRIEF DESCRIPTION OF THE DRAWINGS

FIG. 1 is a front elevation view of a tennis scoring apparatus in accord with the present invention.

FIG. 2 is a side elevation view of another embodiment of a tennis scoring apparatus in accord with the present invention.

FIG. 3 illustrates in greater detail that portion of FIG. 1 in the circle.

### DETAILED DESCRIPTION OF THE PRESENT INVENTION

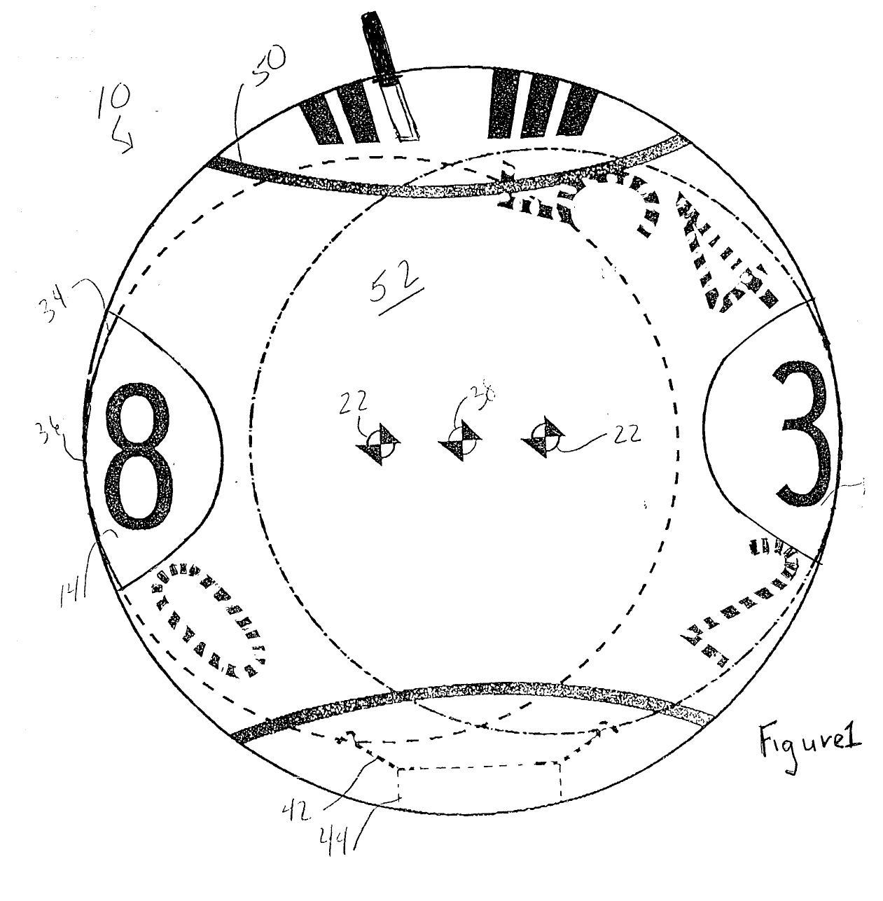

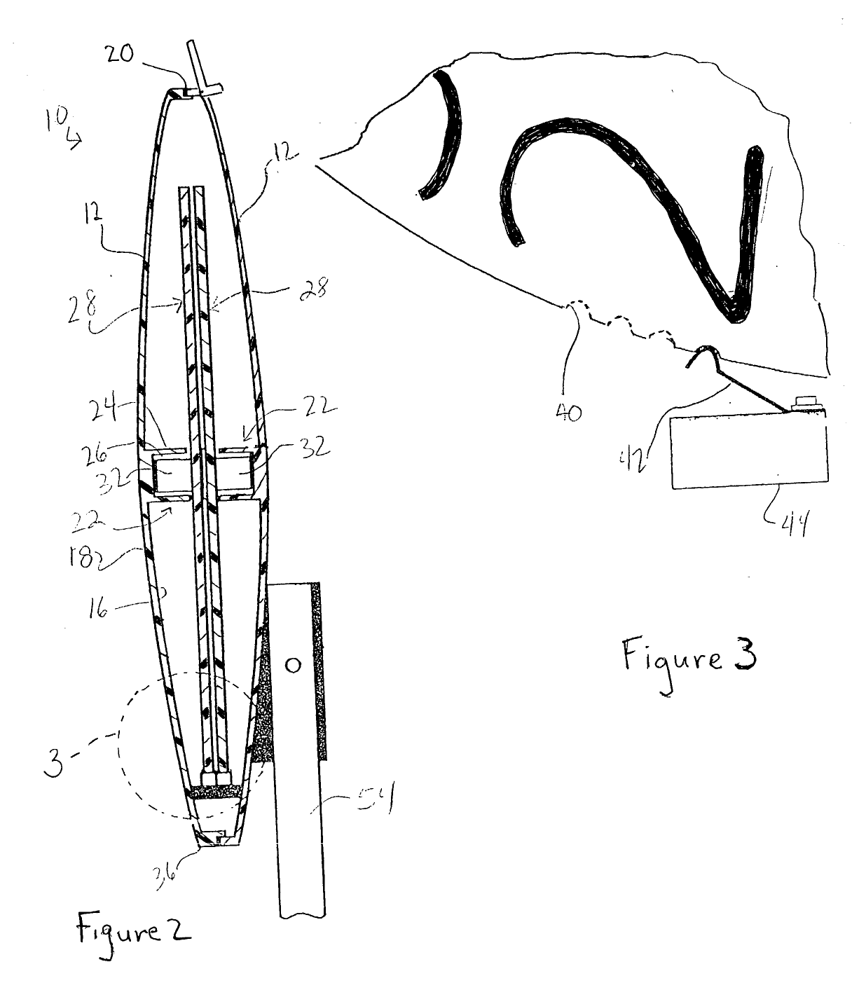

The present invention will be described generally relative to FIGS. 1 and 2, which illustrate a tennis scoreboard 10 in accord with the present invention. As seen in the Figures, scoreboard 10 comprises a pair of baseplates 12 each substantially in the form of a convex disk. Each baseplate 12 includes a pair of openings or windows 14 that extend through the baseplate 12 from the back surface 16 to the front surface 18. The outer edges 20 of each base plate 12 face inwardly to engage each other. The outer edges 20 are fixedly attached to each other along in any known manner such as a tongue and groove joint. If desired, the attachment may be made with an adhesive so as to be permanent or nearly so. The baseplates 12 each include a substantially centrally disposed mounting structure 22. Mounting structures 22 each include a wall 24 extending inwardly from baseplate inner surface 16 and defining a recess 26. Each recess 26 preferably takes the form of a cylinder capable of receiving a tubular pin or axle, as will be described further below.

Also shown in the Figures are a pair of scoring wheels 28. Each scoring wheel 28 is rotatably engaged with one of the baseplates 12. For example, each scoring wheel 18 is rotatably engaged with a baseplate 12 by an axle 32 that extends outwardly into a recess 26 of the base plate 12 mounting structure 22. Other known means of rotational engagement between the scoring wheels 28 and the baseplates 12 may also be used.

Referring particularly to FIG. 1, it will be observed that each scoring wheel has a substantially circular configuration with a diameter less than that of the baseplates 12. The mounting structures 22 are disposed on the inner surface 16 offset from the center 38 of the baseplate 12 so as to receive the axle 32 and rotatably mount the scoring wheel such that its outer edge 34 is“coincident” with the radially outermost edge 36 of the baseplate 12.

Each scoring wheel 28 includes the numerals 1 to 8 inclusive numerically displayed thereon. The numerals 1-8, inclusive, found on each scoring wheel 28 are preferentially arranged adjacent the scoring wheel outer edge 34, thereof. Furthermore, the numerals are preferentially configured to be no larger than the size of baseplate windows 14 to prevent any obscuring thereof by the baseplate itself. Preferably, each window 14 and the numerals will be appropriately and cooperatively sized to ensure that the entire numeral will be clearly visible through the window.

It will be observed that the attachment points 22 and the baseplate centers 38 all lie along a common diameter. In such a configuration, that is, one where the windows 14 are diametrically opposite to each other as shown in the Figure, the numerals should be arranged relative to the scoring wheels so as to be in an upright position relative to a diameter of the scoring wheel drawn through the center of the numeral, thus ensuring that the numeral will appear upright in the windows. It will be understood that, consistent with the scope and spirit of the present invention that the windows 14 need not be diametrically opposed and that in such an embodiment, the numerals positions will need to be rotated accordingly so as to appear upright in the non-diametrically opposed windows.

It will be observed that each scoring wheel 28 includes the cardinal numbers 1 to 8 inclusive on its outwardly facing surface. Each scoring wheel is attached to the baseplate 12 such that as the scoring wheel is rotated, one of the numbers 1-8 will successively appear in the windows while the remaining seven numbers remain hidden behind the baseplate 12. In this manner, then, rotation of the scoring wheels enables a single numeral representative of each player's score to appear in a window, thus displaying the current game score.

As shown in the present embodiment, each scoring wheel 28 is free to rotate relative to its baseplate 12. To prevent free-wheeling of the scoring wheels, a rotation control apparatus is provided. Thus, each wheel 28 includes a plurality of notches 40 to facilitate rotation control thereof. In the embodiment shown in the Figures, the notches 40 are disposed at 40 degree intervals about the edge 34 and total nine in all. Notches 40 are selectively engaged by a spring loaded arm 42 attached to a mounting bracket 44. That is, arm 42 is spring loaded so as to be biased normally upwardly toward engagement with the scoring wheel 28. The arm 42 includes a U-shaped end that is configured to be received by the notches 40 and to prevent rotation of the wheel 28. To change scores then as the score of the game changes, a player or scorekeeper can grasp the edge of the scoring wheel and apply a rotational motion to it. As the wheel rotates, the arm 42 will be forced out of the notch 40 and will slide along the edge 34 until the next notch is reached. The arm and particularly the U-shaped end will engage the next stop, inhibiting further rotation. This rotation inhibition will be sensed by the scorer, who will then stop further efforts to rotate the wheel, thereby having advanced the wheel by one point. It will further be observed that the baseplate 12 includes the familiar “seam” 50 found on currently manufactured and sold tennis balls, thus evoking in anyone who observes the scoreboard 10 thoughts reminiscent of such products. In addition, the baseplate can assume the color of tennis balls sold popularly in any particular geographic region, thus enhancing the visual recognition. The scoring wheels 28 can assume other colors as desired, as can the numerals thereon. The central portion 52 of the baseplate can be used to display advertising if desired. This area can be made larger and more prominent by placing the windows 14 at other locations, such as at 135 and 225 degrees as measured from a radius extending vertically upward or at 45 and 315 degrees; in other words, approximately 90° apart, for example, in the lower or upper portions of the baseplate 12. The positions of the disks and their attachments to the baseplate would thus be accordingly modified. All such alternative positionings are within the scope of the present invention.

Baseplate 12 and scoring wheels 28 can be manufactured from appropriate materials, such as plastics or metals such as steel or aluminum and then appropriately treated, all as is well known, so as to be able to display for long periods of time the information previously mentioned herein. Preferably, the scoreboard 10 can be manufactured to admirably withstand adverse weather conditions for many years.

The scoreboard 10 can be mounted to a standard 54 by any known means. For example, as shown in FIG. 2, a molded sleeve conforming to the cross sectional shape and size of the standard 54 may be attached to the scoreboard 10 and received by the standard 54. Alternatively, scoreboard 10 can be supported so as to be in an upright position by any known means.

The size of the scoreboard 10 can be selectively determined as desired. For example, in one embodiment, the baseplate 10 could have a diameter of 42 inches and the scoring wheels could have diameters of 33 inches.

The present invention having thus been described, other modifications, alterations, or substitutions may now suggest themselves to those skilled in the art, all of which are within the spirit and the scope of the present invention. It is therefore intended that the present invention be limited only by the scope of the attached claims below.

What is claimed:

1. A tennis scoreboard comprising:
at least one baseplate having front and rear surfaces, said at least one baseplate including a pair of windows extending between said front and rear baseplate surfaces; and a pair of scoring wheels rotatably attached to said baseplate, each scoring wheel including the numerals 1 to 8 inclusive arranged about the perimeter of said scoring wheel, wherein said scoring wheels are attached to such baseplate such that only a single numeral will show through its respective baseplate window.

2. The scoreboard of claim 1 wherein said numerals are configured to be no larger than the size of said baseplate windows.

3. The scoreboard of claim 1 wherein said baseplate has a substantially disk-like configuration.

4. The scoreboard of claim 3 wherein said windows lie adjacent the periphery of said baseplate.

5. The scoreboard of claim 4 wherein said windows are diametrically opposed to each other.

6. The scoreboard of claim 3 wherein said windows are diametrically opposed to each other.

7. The scoreboard of claim 1 wherein said baseplate has a substantially disk-like configuration and is configured to resemble a tennis ball.

8. The scoreboard of claim 7 wherein said numerals are configured to be no larger than the size of said baseplate windows.

9. The scoreboard of claim 7 wherein said windows lie adjacent the periphery of said baseplate.

10. The scoreboard of claim 9 wherein said numerals are configured to be no larger than the size of said baseplate windows.

11. The scoreboard of claim 9 wherein said windows are diametrically opposed to each other.

12. The scoreboard of claim 7 wherein said windows are diametrically opposed to each other.

13. The scoreboard of claim 1 and further including means for preventing free rotation of said scoring wheels.

14. The scoreboard of claim 13 wherein said rotation prevention means comprises:
each said scoring wheel includes an outer edge and said scoring wheel outer edge includes a plurality of notches; and;
an arm having a free end for engaging said notches, said arm being biased into engagement with said notches.

15. A tennis scoreboard comprising:
a pair of baseplates, each said baseplate including an outer edge with said outer edges being attached to each other and further including a pair of windows;
a pair of scoring wheels rotatably mounted between said baseplates, each said baseplate including a plurality of scoring numerals on each side thereof, each said scoring wheel being mounted such that its respective scoring numerals on one side thereof are successively visible in one of said baseplate windows and its respective scoring numerals on the other side thereof are visible in the opposing window of said other baseplate.

16. The scoreboard of claim 15 and further including means for preventing free rotation of said scoring wheels.

17. The scoreboard of claim 16 wherein said rotation prevention means comprises:
each said scoring wheel includes an outer edge and said scoring wheel outer edge includes a plurality of notches; and;
an arm having a free end for engaging said notches, said arm being biased into engagement with said notches.

18. The scoreboard of claim 15 wherein said numerals are configured to be no larger than the size of said baseplate windows.

19. The scoreboard of claim 15 wherein said baseplate has a substantially disk-like configuration.

20. The scoreboard of claim 19 wherein said windows lie adjacent the periphery of said baseplate.

21. The scoreboard of claim 20 wherein said windows are diametrically opposed to each other.

22. The scoreboard of claim 19 wherein said windows are diametrically opposed to each other.

23. The scoreboard of claim 15 wherein said baseplate has a substantially disk-like configuration and is configured to resemble a tennis ball.
